(19) United States
(12) Patent Application Publication
(10) Pub. No.: US 2025/0199520 A1
(43) Pub. Date: Jun. 19, 2025

(54) IDENTIFYING AND REPAIRING A DEFECT DURING AN ADDITIVE MANUFACTURING PROCESS

(71) Applicant: Corps Technologies LLC, Campobello, NC (US)

(72) Inventor: Michael Moore, Charlotte, NC (US)

(21) Appl. No.: 18/988,079

(22) Filed: Dec. 19, 2024

Related U.S. Application Data
(60) Provisional application No. 63/612,024, filed on Dec. 19, 2023.

(51) Int. Cl. G05B 19/418

(52) U.S. Cl. CPC G05B 19/41875; G05B 2219/49023

(57) ABSTRACT

Methods and systems for identifying a defect in an additive manufacturing process. One or more robots are configured for manufacturing, inspection, and repair of material. One or more sensors are configured for analyzing the material. A memory includes instructions and at least one processor configured to execute the instructions. The instructions are configured to cause the robot(s) and/or a corresponding computing platform to perform steps including receiving information from the one or more sensors during deposition of the material and obtaining microstructure information specific to the material being deposited from a predictive index. The steps also include assigning a weight to the output of, or to a defect probability determined from the output of, at least one of the one or more sensors. The steps also include determining, using the weighted information, the likelihood of a defect in the material.

### CROSS-REFERENCE TO RELATED APPLICATIONS

The present application claims the benefit of U.S. Provisional App. Ser. No. 63/612,024, entitled “Identifying and Repairing a Defect During an Additive Manufacturing Process,” filed Dec. 19, 2023. The foregoing application is incorporated by reference herein in its entirety for all purposes.

### TECHNICAL FIELD

Embodiments of the invention relate to identifying and repairing a defect formed during an additive manufacturing process. More specifically, embodiments of the invention relate to inspecting, identifying, and repairing defects formed during an automated wire arc additive manufacturing process of metal and metal alloys.

### BACKGROUND

Additive manufacturing involves the creation of a three-dimensional object or component, typically from a digital three-dimensional model. Additive manufacturing can be performed in a variety of processes in which material is deposited, joined, or solidified under computer control. Material is added together (such as metals, alloys, plastics, liquids or powder grains being fused), typically layer by layer in order to build the three-dimensional object or component.

The market for high-mix/low-volume production of specialized or tailored metal alloys is driving demand for the creation for robotic arc directed energy deposition additive manufacturing systems capable of producing products at near-net-shape and on demand.

The mechanical properties (such as strength, hardness, and toughness) of a metal or metal alloy are highly dependent on the thermal history of the metal or metal alloy at issue. The number of heating and cooling cycles involved with additive manufacturing of these materials adds to the complexity of manufacturing large parts in an environment outside of a controlled laboratory. Defects can occur during the deposition of metal or metal alloys. They can in some cases lead to failure of a component and they can be costly if not identified and repaired.

### SUMMARY

In one embodiment, the present invention provides a system for identifying a defect in an additive manufacturing process. The system comprises a robotic arm configured for manufacturing a three-dimensional object by melting and solidifying a metal material via a heat source. The system also includes one or more sensors configured for monitoring the metal material during manufacture of the three-dimensional object. Further, the system includes memory comprising instructions and at least one processor configured to execute the instructions to perform various steps. The steps comprise receiving information from the one or more sensors during manufacture of the three-dimensional object, receiving information regarding a microstructure of the metal material, assigning a weight to the information from the one or more sensors based on one or more of the information received regarding the microstructure of the metal material, the operating characteristics of the one or more sensors, and the geometry of the three-dimensional object, and determining, using the weighted information, the likelihood of a defect in the material.

In accordance with another embodiment, the present invention provides a method for identifying a defect in an additive manufacturing process. The method comprises the operations of receiving information from one or more sensors during deposition of a metal material by a manufacturing robot during manufacture of a three-dimensional object and receiving information regarding operating characteristics of the one or more sensors and regarding the metal material's expected microstructure under the predetermined manufacturing conditions. Further the method comprises weighting the information from one or more sensors based on the received information. Finally, the method comprises determining, using the weighted information, a first likelihood of a defect in the material.

In accordance with yet another embodiment, the present invention provides a system for identifying a defect in an additive manufacturing process. The system comprises a manufacturing robot configured for additive manufacturing of a three-dimensional object from a metal material under predetermined manufacturing conditions. Also, the system comprises a plurality of sensors positioned to monitor deposited metal material during manufacture of the three-dimensional object, the sensors each having operational characteristics under the predetermined manufacturing conditions. The system further comprises a predictive index comprising information regarding susceptibility of the deposited metal material to a manufacturing defect. Also, the system comprises memory comprising instructions and at least one processor in communication with the manufacturing robot, the one or more sensors, the predictive index, and the memory. The processor is configured to execute the instructions to perform steps comprising receiving sensor data from each of the plurality of sensors during manufacture of the three-dimensional object and receiving from a predictive index information regarding susceptibility of the deposited metal material to a manufacturing defect. Also, the processor is configured to execute the instructions to perform the step of assigning a weight to the sensor data from each sensor of the plurality of sensors in part based on the operational characteristics of the plurality of sensors under the manufacturing conditions of the three-dimensional object. Further the processor is configured to execute the instructions to perform the step of determining a first likelihood of a defect in the deposited material based on the weighted sensor data and the information regarding susceptibility of the deposited metal material to a defect.

### BRIEF DESCRIPTION OF THE DRAWINGS

FIG. 1 is a side view of a system for identifying and/or correcting a defect in an additive manufacturing process in accordance with an embodiment of the present disclosure;

FIG. 2 is a schematic illustration of a system for identifying and/or correcting a defect in an additive manufacturing process in accordance with an embodiment of the present disclosure;

FIG. 3 is a flowchart of a method for identifying and/or correcting a defect in an additive manufacturing process in accordance with an embodiment of the present disclosure;

FIG. 4 is a flowchart of a method for identifying and/or correcting a defect in an additive manufacturing process in accordance with an embodiment of the present disclosure;

FIG. 5 is a block diagram of a system for identifying and/or correcting a defect in accordance with yet another embodiment of the present disclosure;

FIG. 6 is a block diagram of a robotic system that can be used with the system of FIG. 5;

FIG. 7 is a block diagram of a sensory system that can be used with the system of FIG. 5;

FIG. 8 is a flowchart of an algorithm for identifying and/or correcting a defect that can be used in the system of FIG. 5;

FIG. 9 is a diagram of various inputs that may be fed into the algorithm of FIG. 9 in accordance with one embodiment of the present disclosure; and

FIG. 10 is a perspective view of the robotic system of FIG. 6, including detail views of certain components in accordance with an embodiment of the present disclosure.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

For purposes of promoting an understanding of the principles of the present disclosure, reference is now made to the examples illustrated in the drawings, which are described below. The illustrated examples disclosed herein are not intended to be exhaustive or to limit the disclosure to the precise form disclosed in the following detailed description. Rather, these exemplary embodiments were chosen and described so that others skilled in the art may use their teachings. It is not beyond the scope of this disclosure to have a number (e.g., all) the features in a given example used across all examples. Thus, no one figure should be interpreted as having any dependency or requirement related to any single component or combination of components illustrated therein. Additionally, various components depicted in a given figure may be, in examples, integrated with various ones of the other components depicted therein (and/or components not illustrated), all of which are considered to be within the ambit of the present disclosure.

Embodiments of the present invention relate to systems and methods for locating a defect in one or more layers of material deposited during an additive manufacturing process and repairing the defect with optimized efficiency. As discussed in greater detail herein, various embodiments of the present invention are more efficient and cost-effective than processes that use mathematical modeling and/or experimental data to attempt to predict occurrence of a defect prior to a part being manufactured and to create a defect-free toolpath. For example, while a defect free weld can be made in the Rene 65 alloy by doing 256 small weld passes, in most real-world applications, normal weld procedures would only employ 8-10 passes. The defect-free toolpath approach is not viable because it takes 25-30 times longer in this example and would be much more expensive. In various embodiments of the present invention, the 8-10 pass toolpath model may be employed and any defects efficiently identified and repaired with a nominal impact on the budgetary cost. Various embodiments of the present invention can be used to identify a defect, remove the defect via a hybrid robotic cell equipped with a high-RPM spindle suitable for carbide burrs, replace the metal or alloy that has been removed, and re-level the part or object dimensionally.

Certain embodiments of the present invention may incorporate multiple functionally independent, yet coordinated systems that are integrated to precisely share data for the purpose of making high-integrity near-net-shape components. The first such system may intake a 3D-CAD file for a particular part, process the 3D-CAD file using suitable software (e.g., Autodesk PowerMill) to “slice” the part into a plurality of layers and generate a tool path (or code representative thereof) for a robotic welding system. The robotic welding system may consistently and repeatably deposit beads of material (e.g., metal) and layers to a near-net shape. The second such system may employ a plurality of sensors to gather data that are used in detecting and repairing a defect in one or more layers. As discussed in more detail herein, weights may be automatically applied to information from the sensors prior to making a determination regarding whether a defect is present. In various embodiments, the weights may be empirically-derived and may be based on information regarding a material's microstructure and susceptibility to defects under certain conditions. Certain embodiments may allow for human override of the defect determination. The robotic welding system may also remove a detected defect and replace it with new material to its prior dimensions.

Although embodiments of the present invention are discussed below in the context of an automated wire arc additive manufacturing process involving certain metals and metal alloys, those of skill in the art will appreciate that the present invention is not so limited. Embodiments of the present invention may be used with any additive manufacturing process involving any suitable material familiar to those of ordinary skill in the art. Moreover, where the additive manufacturing process at issue involves welding, any type of welding may be used, including MIG/MAG, TIG, and laser welding, among others.

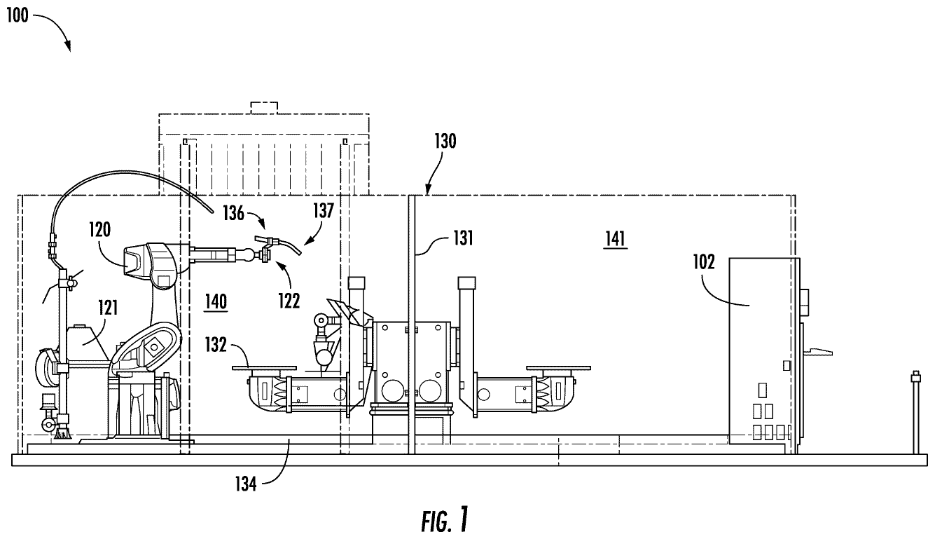

Turning now to the figures, FIG. 1 is a side view of a system 100 for identifying and/or correcting a defect in an additive manufacturing process. The system 100 can be located within and include a defined workspace 130. The workspace 130 can include one or more walls 131 to set forth a work area. The one or more walls 131 may be configured to separate the workspace 130 into a first area 140 and a second area 141. The first area 140 or the second area 141 can be used for manufacturing or repairing a component as needed. A support surface 132 is located within the workspace 130 for supporting a component that is being formed.

In this embodiment, system 100 includes a control system 102, in the form of one or more computing platforms, to control operations of the system 100. Also in this embodiment, the control system 102 is electronically connected (directly or indirectly) to each component of the system 100 and is configured for providing instructions throughout the system 100. The system 100 includes a manufacturing robot 120 that, in this embodiment, comprises at least one robotic arm. As those of skill in the art will appreciate, however, in various embodiments system 100 may include a dedicated controller for manufacturing robot 120 that is in electronic communication with another controller, for example that controls the overall system and receives and outputs information regarding an object to be built by manufacturing robot 120.

In various embodiments, manufacturing robot 120 can be any known manufacturing robot or 3D Printer used for an additive manufacturing process of metal or metal alloys. One example of a suitable manufacturing robot 120 is the QIROX line of automated welding and cutting/grinding robots offered by CLOOS Robotic Welding, Inc. of Shaumburg, Illinois. As those of skill in the art will appreciate, manufacturing robot 120 can be configured to consistently and repeatably manufacture a component by melting and solidifying metal wire or powder via a heat source, such as an arc or laser. In this case, metal wire is fed via a wire drive 121, melted, and then deposited layer-by-layer (e.g., as weld beads) into a near-net shape. In various embodiments, the manufacturing robot 120 can be movable along 6 axes or 7 axes and mounted on one or more rails or guides 134 for increased mobility.

In various embodiments, robot 120 can include a tool changing system and/or an interchangeable tool head 136. The tool changing system 136 is configured to allow for use of various tools with the robot 120. For example, the tool changing system 136 allows robot 120 to change between use of a welding torch 137, a high RPM spindle configured for receiving a carbide burr, a leveling device, a measuring device, and/or other tools useful for inspecting and repairing a component formed during an additive manufacturing process. In various embodiments, robot 120 receives instructions from the control system 102. Also in various embodiments, more than one robot 120 may be provided, and system 100 can in some cases also include a dedicated robot for inspection, sensing, and/or repair of defects. For instance, in some embodiments discussed below, a system like system 100 could include a manufacturing robot 120 and a separate inspection and repair robot with sensors and a tool changing system, and the inspection and repair robot's controller and feedback signals may be integrated with those of manufacturing robot 120. As will be appreciated, the three-dimensional position of robot 120 (including, for example, the precise location of welding torch 137 in the coordinate system of workspace 130) is known to robot 120, its controller, and/or control system 102.

The system 100 includes one or more sensors 122 configured to provide real-time feedback of deposition of material during an additive manufacturing process. The one or more sensors 122 can be positioned within the workspace 130 to monitor the deposition of material. One or more sensors 122 can be mounted on the manufacturing robot 120, or at a remote location within the workspace 130. In various embodiments, the one or more sensors 122 may monitor the deposition process during deposition of a layer (or portion thereof) and/or after the layer or portion solidifies. In various embodiments, scanning with the one or more sensors 122 can occur at various times, but scanning with the one or more sensors 122 need not interfere with the deposition process. In one aspect, each layer of deposited material is scanned by the one or more sensors 122 prior to deposition of the next layer. In another aspect, sensor monitoring is done continuously. In some aspects, the data from the one or more sensors 122 is only used in analysis for sensing done on layers, or portions of layers, that have recently solidified. In one embodiment, certain of sensors 122 are used to scan not only the most recently deposited layer, but also one or more previous layers of deposited material, such as two, three, or more layers in total. In other embodiments, sensor 122 data can be acquired for a single layer (e.g., the most recent layer or an older layer), or two or more layers. In some embodiments, when a defect is identified, the deposition process is stopped while the defect is repaired.

In various embodiments, sensors 122 can include sensors for dimensional accuracy, for sensing the surface conditions, and for sensing sub-surface conditions. Sensors in the first category may include a laser profilometer for measuring deposit height. Sensors in the second category can include visual and infrared cameras collecting data regarding material deposition, solidification, peak temperature, heating and cooling rates, and the presence of cracks or porosity visible to the human eye. Surface cracks also could be detected by ultrasonic sensors in some embodiments. Sensors in the third category can include non-contact probes that use ultrasound to detect discontinuities and the locations thereof below the surface. Also, temperature-related probes, such as an infrared camera, can be used to predict the microstructure at a specific location below the surface that is used to determine susceptibility to a potential defect.

The one or more sensors 122 can include, in various embodiments, one or more non-contact probes, such as electromagnetic acoustic transducers, air-coupled transducers, and a laser interferometric sensor (such as but not limited to a laser profilometer). Sensors 122 can also include a welding microphone, a visual camera, an infrared camera, an ultrasound probe, a position sensor, and/or a bead profiler, among others. The one or more sensors 122 provide information to the control system 102 which can be used as feedback to control a welding process or for inspecting and repairing any defect in the material. The information provided by the one or more sensors 122 can include, for example, precise parameter control with in-situ adjustments, location information, shape information, size information, thermal information, composition information, audio signal from deposition process, visual images of material, and surface scans, among other things.

As one example, a camera-based sensor 122 can evaluate a molten pool at the point of deposit as well as solid-state conditions after solidification. As those of skill in the art will appreciate, solidification conditions can contribute to potential defects. The shape of the molten pool (e.g., teardrop and elongated versus round or elliptical) can affect the susceptibility of the material's microstructure to cracking by influencing the grain boundary morphology. Whereas long, straight grain boundaries are susceptible to cracking, tortuous grain boundaries are more resistant, and using visual scans of the molten pool at a particular location can help identify potential defects.

As yet another example, an artificial intelligence algorithm coupled with visual images from one or more weld cameras can be used to identify potential defects. In this regard, those of skill in the art will appreciate that clean metal deposits are made when stable metal transfer occurs. The visual image of the electric arc, metal droplet formation, and transfer are all indicative of a homogenous, stable arc, free from spatter and disruption. The acoustic signature of a stable arc also is homogenous. Coupling the visual image with an acoustic signature can identify potential defects by identifying non-homogenous conditions.

Those of skill in the art are familiar with suitable sensors 122 that can be used in various embodiments of the present invention. One example of a suitable electromagnetic acoustic transducer is the S7382 EMAT transducer with circular polarization for high-temperature applications offered by ACS-Solutions GmbH of Saarbrücken, Germany. One example of a laser profiler or laser displacement sensor are the 2D/3D laser profilers offered by Keyence Corporation of America, located in Itasca, Illinois. Suitable air coupled transducers may include a piezocomposite material and matching layers to reduce the impedance mismatch between the transducer and air and may comprise capacitive and/or piezoelectric micromachined ultrasonic transducers (CMUTs and PMUTs). Other air-coupled transducers may comprise ferroelectret transducers, thermoacoustic transducers, and/or plasma-based transducers. Examples of visual and infrared cameras include the high dynamic range (HDR) visual cameras and the thermal short-wave infrared (SWIR) cameras offered by Xiris Automation Inc. of Burlington, Ontario, Canada. One example of a suitable microphone is the WeldMic welding microphone alone or in combination with the Audio AI tool offered by Xiris Automation. An example of a suitable bead profiler is the BeadScan sensor and image processing system offered by Xiris Automation.

In one example of operation, a manufacturing program or 3D-CAD file corresponding to a part or object to be built is transmitted from control system 102 to manufacturing robot 120, or to a dedicated controller associated therewith. The manufacturing program or 3D-CAD file comprises information necessary to make and instructions for making the part or object. Those of skill in the art are familiar with such manufacturing programs and CAD files. The manufacturing robot 120 or its dedicated controller executes the manufacturing program to drive robot 120, the wire in wire drive 121, a welding power source, and uses welding torch 137 to form a weld bead in accordance with the manufacturing program. In other words, the manufacturing robot 120 or its control system may drive the robot arm or welding torch 137 along a predetermined tool path or welding track and drives the wire and an associated power source according to a predetermined welding condition to melt and solidify the wire at the tip of welding torch 137 by electric arc. As will be understood, weld beads are deposited adjacent to one another in order to form a weld bead layer, and subsequently another weld bead layer is placed on that weld bead layer. These steps, along with other operations discussed herein, are repeated to form a three-dimensional part or object.

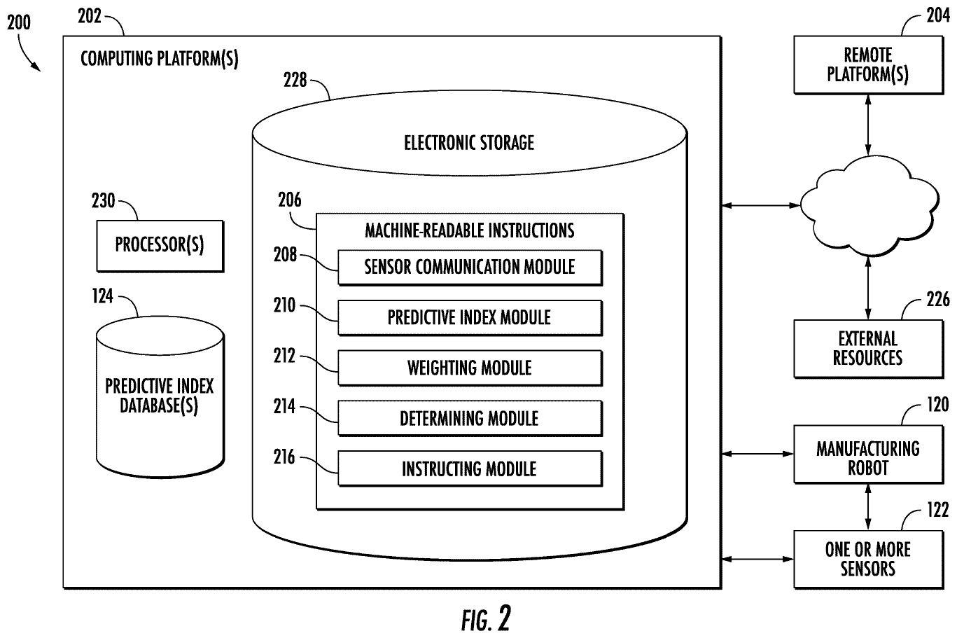

FIG. 2 is a schematic illustration of a system 200 configured for identifying and/or correcting a defect in an additive manufacturing process, in accordance with one or more implementations. In some implementations, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of a sensor communication module 208, a predictive index module 210, a weighting module 212, a determining module 214, an instructing module 216, and/or other instruction modules.

Sensor communication module 208 may be configured for communicating with (e.g., sending information to and/or receiving information from) the one or more sensors 122 during the deposition of material in an additive manufacturing process. In various embodiments, the information may be communicated in real-time throughout the additive manufacturing process or at predetermined intervals. Information may be transmitted over any wired or wireless communication channel. In various embodiments, information from each of the one or more sensors 122 is communicated for or associated with specific locations (e.g., in spherical, cartesian, or polar coordinates) of material deposited during an additive manufacturing process.

In some embodiments, the sensor communication module 208 may also receive information regarding and/or determine whether each sensor 122's output indicates that a defect exists based on that sensor's sensed data. In this regard, in some embodiments, the sensor 122 output may comprise an indication of whether a defect exists at a given location. In some embodiments, the sensor 122 output may comprise a probability of whether a defect exists at a given location. Alternatively, the output of sensor(s) 122 may comprise only sensed values in some embodiments. In that case, for example, sensor communication module 208 or another module in machine-readable instructions 206 (such as predictive index module 210, weighting module 212, determining module 214, or another module) may evaluate the sensed data, such as by comparing it against predetermined criteria or thresholds, to obtain an indication or probability of whether a defect exists at a given location for each sensor 122. In various embodiments, the predetermined criteria and/or thresholds can vary depending on the location at issue, the metal or alloy system being used, and/or user specifications.

Various embodiments of system 200 also include a predictive index, which in this embodiment comprises a predictive index module 210 that is configured for communicating with predictive index database(s) 124 to obtain information specific to the material being deposited and/or the part being manufactured. In various embodiments, predictive index database(s) 124 can be separate from machine-readable instructions 206, as shown, but in other embodiments, predictive index database(s) 124 can be included in electronic storage 228 of computing platform(s) 202. Also, information from the one or more sensors 122 preferably is fed to the predictive index module 210 and/or database(s) 124, and the predictive index module 210 may use this information in its analysis of the metal or alloy system at issue.

In general, a predictive index in accordance with embodiments of the invention comprises one or more databases including information regarding a metal or alloy system's susceptibility to “weldability” issues or potential defects based on time, temperature, composition, and resultant microstructure. Such information can come, for example, from existing peer-reviewed literature or other sources. In the predictive index, each “weldability” issue can have a “signature” that makes one or more sensors predictive than others (e.g., ultrasonic inspection is predictive of cracking and interior porosity, but a laser profilometer will not detect internal cracking; auditory signature is predictive for porosity, a laser profilometer is predictive of surface porosity, etc.). In various embodiments, and as described below, a material that is not susceptible to cracking will see the sensors best-suited for crack detection either disregarded or down-weighted.

The databases also include information regarding the microstructure at, e.g., X, Y, Z locations for a particular alloy system. Such information can be empirically-derived, for example, by creating one or more test blocks of a given material to “calibrate” system 200, which operates in an additive manufacturing context, to account for weldability issues for that given material that were identified in a different welding context. This may be the case, for example, where known data identifying weldability issues for certain materials is obtained in a more traditional welding context. For instance, this information can contain developed procedures (e.g., parameters of wire feed speed (current), voltage, pulse settings, contact tip to work distance, and/or travel speed) and/or information regarding what the microstructure for a given part is expected to be in a specific three-dimensional location in the part.

In some embodiments, the databases in the predictive index can also include an AI-capable system to review newest peer reviewed advances based, for example, upon the “impact factor” of the publications. In some embodiments, the predictive index databases can also include information regarding the reliability of a particular sensor in a particular situation or under particular manufacturing conditions, although in other embodiments this information also can be stored elsewhere in computer platform(s) 202.

In various embodiments, the predictive index can access information associated with subsurface microstructure morphology for various materials under various manufacturing conditions, such as information regarding microstructure for a given alloy at given peak temperatures, cooling rates, and/or heating rates. In various embodiments, the predictive index can employ empirical data based upon experimental results to predict the susceptibility of a material's microstructure to specific categories of defects (e.g., cracking, microvoids, etc.) at specific locations during an additive manufacturing process. In this regard, material properties and manufacturing conditions, such as the material's chemical composition, peak temperature, time at temperature, and cooling rates, can provide a reasonable estimate as to what phases or constituents might be present at any given location during a build. For instance, information in the predictive index database(s) may indicate that austenite, martensite, chromium carbides, and/or other microstructure morphologies (e.g., large grain size) are present at any given location in a build based on the chemical composition of the material, peak temperature, and heating and cooling conditions associated with the build at that location.

As noted, the predictive index can include information about a plurality of metals and metal alloys. In one embodiment, for example, the predictive index includes information about stainless steels (302L, 304L, 308L, 309L, 316L and LSI versions), Nickel based alloys (625 and other Inconel compositions), Advanced High Strength Steels (Fe-10Ni and other HSLAs such as HSLA 100, 130), Copper Alloys (NAB, Cupronickel), Titanium alloys (6-4), Aluminums (3000, 4000, 5000, 6000 and 7000 series), and combinations thereof. In one embodiment, this information in the predictive index database(s) is developed based on empirical data regarding morphology obtained in experiments for each alloy or metal to be used.

As shown, the predictive index can comprise a software program or other machine-readable instructions that communicate with the one or more databases and with the one or more sensors 122. In some cases, the predictive index can comprise a standalone software program that is in electronic communication with computing platform(s) 202 and the one or more sensors 122. In other embodiments, the predictive index comprises a software program or computer code that is a part of machine-readable instructions 206, and the database(s) associated with the predictive index can be either in electronic storage 228 or in a remote location. Those of skill in the art will appreciate that other operational configurations are possible and within the scope of the present invention.

The computing platform(s) 202 can access some or all of the specific information described above via the predictive index. Computing platform(s) 202 may use this information to determine whether the material is susceptible or not susceptible to a defect at that location based on the information received from predictive index. In other embodiments, the predictive index may itself indicate whether the material's microstructure is susceptible or not susceptible to a defect at that location. In some embodiments, the predictive index uses empirical data regarding morphology to call up code or logic (e.g., IF/THEN) for different metal or alloy systems. Computing platform(s) 202 may also use information from the predictive index to determine if a particular metal or alloy system has certain weldability issues or is likely to have certain defects in certain conditions. Such information may also influence the sensors 122 used in a given situation or the weights assigned to given sensor 122 outputs.

In some specific embodiments, the susceptibility (or non-susceptibility) output obtained from or determined based on information from the predictive index can be graded as “Low,” “Mid,” and “High” in each case for more information or to improve accuracy. For example, these “Low,” “Mid,” and “High” grades can be useful depending on the criticality of the part being produced and/or the location of the part being produced in a system. For instance, MIL Spec products done for a U.S. Department of Defense application might have much tighter or stricter acceptance criteria and thus will need to be treated accordingly. A load bearing part or portion of a part likewise can require stricter acceptance criteria (e.g., seismic code for structural steel applications have special code requirements that apply to “demand-critical” joints that are not applicable to non-demand-critical joints). Also, in Nickel-based alloys, “sigma phase,” or in austenitic stainless steels, carbide formation, can degrade the performance of the material in service. Temperature ranges at which these behaviors can be precipitated can be in the range of 450-750 degrees Celsius, although different or more specific ranges for specific alloys can apply, and time at temperature also is a factor.

Weighting module 212 may be configured for generating weights to be assigned to information received from one or more sensors 122. In various embodiments, the weights can be purely objective (e.g., data driven) or they can have some element of human subjectivity, for example depending on the code or application for which embodiments of the present invention are being utilized. In one example, the data or information provided by the one or more sensors 122 can be ranked from most reliable to least reliable.

In one embodiment, weights can be based on the reliability of a particular sensor in a particular situation or under particular manufacturing conditions, on information from the predictive index, and/or information regarding the location in the build (considering geometric factors), among other things. For example, for an alloy system where carbide formation is not likely due to chemical composition (e.g., no chromium thus no chromium carbides), then a temperature sensor may be downgraded in terms of weighting or may be assigned a lower weight. Additionally, a system known to have poor emissivity readings due to heavy oxide formation may have readings from infrared sensor(s) downgraded. Also, highly reflective materials can impact readings from laser-based sensors, and those sensors' outputs can be weighted accordingly.

The weighting module 212 may also take into consideration an operating range of the one or more sensors 122. If a sensor is close to the limits of its operating range, then the information or data provided by that sensor is not considered as highly as information or data provided by a sensor in an optimum operating range. For example, an infrared camera may only function between 350 and 1850 degrees Celsius and may also be susceptible to errors based upon changes in emissivity of the surface (e.g., after oxidation), and corrective measures must be taken to offset this issue. The weighting module 212 may also take into consideration error associated with the one or more sensors 122. As noted, the weighting module 212 may also consider the geometry or shape of the part being built, wherein the location at issue may be more susceptible to a defect because of its geometry or shape (e.g., complexity, thinness, curvature, etc.).

In some embodiments, weighting module 212 only uses information from those of the sensor(s) 122 whose output indicates a defect exists or is probable, and weights are only applied to such information. In other embodiments, weighting module 212 uses information from all sensor(s) 122, even those whose output did not indicate that a defect exists. Thus, in certain embodiments, the weight assigned to a sensor 122's data or indication or probability of a defect may be zero (0) (e.g., where the sensor 122's data, or an indication or probability based on the output of a sensor 122, indicates or suggests that a defect does not exist) such that information from that sensor 122 is effectively not considered in the ultimate determination of whether a defect exists. In certain embodiments, if the output of a given sensor 122 indicates (or is determined to indicate) that a defect does not exist or is not probable, then that sensor's data is not used in the weighting or determining modules 212, 214, and only the data from sensor(s) 122 that indicate that a defect exists, or is probable, are used.

Weights determined in weighting module 212 for each sensor 122 may be applied to the indication (yes or no) or probability of whether or not a defect exists for a given location in some embodiments. In other embodiments, the weights determined in weighting module 212 can be applied directly to sensed data, and the sensor(s) 122 and/or computing platform(s) 202 can determine an indication or probability of a defect based on such weighted sensed data. In any event, in various embodiments, the indications or probabilities associated with one or more of sensor(s) 122 are given greater importance than those associated with other sensor(s) 122. Any method of weighting known to those of skill in the art can be used for this purpose. In some embodiments, sensor 122 information that is to be given greater weight can be multiplied by a value indicative of its relative importance, while sensor 122 information that is to be given lesser weight is not multiplied by any value. Alternatively, in some embodiments sensor 122 information that is to be given greater weight is not multiplied by any value, and sensor 122 information that is to be given lesser weight is multiplied by 0 or a value less than 1.

Determining module 214 is configured for determining the existence of a defect in the material or the likelihood or probability that a defect exists. In various embodiments, determining module 214 may use the weighted sensor data, indications, or probabilities in making its determination. In one embodiment, the determining module 114 may compare the weighted information to one or more predetermined thresholds, or other acceptance criteria, to determine the likelihood of a defect or discontinuity in the material. In one aspect, the determining module 214 may utilize one or more artificial intelligence or machine learning algorithms to determine the presence of a defect in the material. In one embodiment, the determining module 214 may take or use a weighted average of some or all of the weighted sensor data, indications, or probabilities, yielding for example a single average value that can be evaluated by computing platform(s) 202 and/or a human operator to decide whether a defect exists and should be repaired.

In certain embodiments, weighting module 212 and/or determining module 214 can also use process instability data. In this regard, those of skill in the art familiar with directed energy deposition additive manufacturing will appreciate that stable metal transfer or process stability is important during operation. Process stability prevents inconsistencies in the surface dimensions and keeps uniformity in the molten pool conditions, all of which influence the heat transfer data. Those of skill in the art are familiar with sensors that can be used to detect process instability. For instance, the Xiris Weld Mic uses auditory signature to detect instability, and its associated software predicts discontinuities like porosity and undercut. Visual cameras also can be useful in detecting changes in process stability. Finally, the DAQ (Data acquisition of current and arc voltage) is also a useful tool in detecting process instability. In various embodiments, process instability data is used to support other sensors' findings of discontinuities. For example, process instability by itself does not mean a defect or discontinuity exists; however, if other sensors flag a potential defect/discontinuity and the process stability sensors show instability, system 200 may use that information to weight the output of the sensors indicating a potential defect/discontinuity more highly, and/or it may be used in the determination of whether a defect is likely or exists.

In some embodiments, each sensor has adjustable acceptance criteria that are compared with the sensed data to determine whether a defect exists. For example, a criteria that is “highly sensitive” to potential defects might define a 51% probability threshold above which a defect is indicated by that sensor. A criteria that is “less sensitive” to potential defects might define a 90% probability threshold above which a defect is indicated by that sensor. Similarly, in some embodiments, the weighting module 212 and/or the determining module 214 may have an analogous adjustable setting indicative of the overall system 200's sensitivity to potential defects. For example, a highly sensitive criteria might define a 51% probability threshold above which material at the suspect location is removed and replaced. A less sensitive criteria might define a 90% probability threshold above which material at the suspect location is removed and replaced.

Instructing module 216 may be configured for instructing the manufacturing robot 120 and/or a dedicated inspection and repair robot for repairing the defect and replacing material. In various embodiments, the instructions may include a predetermined toolpath or build plan to control the movements of the inspection and repair robot 120 in the most efficient way possible. Also, in various embodiments, the instructions may provide the inspection and repair robot 120 with precise information or steps regarding tool choice, tool operation, location, and other parameters necessary to ensure removal of a defect and replacement of material.

In some implementations, computing platform(s) 202, remote platform(s) 204, and/or external resources 226 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 226 may be operatively linked via some other communication media.

A given remote platform 204 may include one or more processors configured to execute computer program modules. The computer program modules may be configured to enable an expert or user associated with the given remote platform 204 to interface with system 200 and/or external resources 226, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 226 may include sources of information outside of system 200, external entities participating with system 200, and/or other resources. In some implementations, some or all of the functionality attributed herein to external resources 226 may be provided by resources included in system 200, and vice versa.

Computing platform(s) 202 may include electronic storage 228, one or more processors 230, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 228 may comprise non-transitory storage media that electronically stores information. The electronic storage media of electronic storage 228 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 228 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 228 may include one or more virtual storage resources (e.g., cloud storage, a virtual private network, and/or other virtual storage resources). Electronic storage 228 may store software algorithms, information determined by processor(s) 230, information received from computing platform(s) 202, information received from remote platform(s) 204, and/or other information that enables computing platform(s) 202 to function as described herein. As noted above, in some embodiments, some or all of the predictive index may be stored in electronic storage 228. In addition or in the alternative, some or all of the predictive index may be stored in a remote platform 204 or located in an external resource 226.

Processor(s) 230 may be configured to provide information processing capabilities in computing platform(s) 202. As such, processor(s) 230 may include one or more of a digital processor, an analog processor, a digital circuit designed to process information, an analog circuit designed to process information, a state machine, and/or other mechanisms for electronically processing information. Although processor(s) 230 is shown in FIG. 2 as a single entity, this is for illustrative purposes only. In some implementations, processor(s) 230 may include a plurality of processing units. These processing units may be physically located within the same device, or processor(s) 230 may represent processing functionality of a plurality of devices operating in coordination. Processor(s) 230 may be configured to execute modules 208, 210, 212, 214, and/or 216, and/or other modules. Processor(s) 230 may be configured to execute modules 208, 210, 212, 214, and/or 216 and/or other modules by software; hardware; firmware; some combination of software, hardware, and/or firmware; and/or other mechanisms for configuring processing capabilities on processor(s) 230. As used herein, the term “module” refers to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, and/or 216 are illustrated in FIG. 2 as being implemented via a single processing unit, in implementations in which processor(s) 230 includes multiple processing units, one or more of modules 208, 210, 212, 214, and/or 216 may be implemented remotely from the other modules. The description of the functionality provided by the different modules 208, 210, 212, 214, and/or 216 described below is for illustrative purposes, and is not intended to be limiting, as any of modules 208, 210, 212, 214, and/or 216 may provide more or less functionality than is described. For example, one or more of modules 208, 210, 212, 214, and/or 216 may be eliminated, and some or all of its functionality may be provided by other ones of modules 208, 210, 212, 214, and/or 216. As another example, processor(s) 230 may be configured to execute one or more additional modules that may perform some or all of the functionality attributed below to one of modules 208, 210, 212, 214, and/or 216.

To illustrate the operation of certain aspects of an embodiment of system 200, consider a high strength steel application for construction equipment. In this regard, computing platform(s) 202 and/or the predictive index may know that cracking is a critical defect to avoid in this application. Further, the predictive index can provide information regarding the likelihood of and factors relevant to cracking in high strength steels, and it may predict that high-hardness martensite can be present in the microstructure under certain conditions. The predictive index also can include information regarding hydrogen-induced cracking (“HIC”) that can occur in high-strength steel additive manufacturing. In this regard, three elements typically are present when HIC occurs: (1) a susceptible microstructure; (2) threshold levels of residual stresses; and (3) threshold levels of hydrogen. Information from the predictive index can influence the sensor(s) 122 used and the behavior that the system will look for to detect this type of cracking.

Based at least in part on this information, information from visual cameras and surface sensing ultrasound is evaluated for cracks at the surface, and information from penetrating ultrasound sensors is evaluated for reflections that show a “signature” of a crack. With regard to HIC, information from temperature sensors can be used to evaluate the susceptibility of the microstructure, dimensional data, geometric data (such as whether the location at issue is at a corner or is a thicker part), interpass temperatures, and heating and cooling rates can inform the buildup of residual stresses, and information from visuals of the surface conditions (e.g., hydrocarbons on the surface), process instability, disruptions of shielding gas flow, and interpass temperatures can inform the presence of threshold levels of hydrogen. All of this information is gathered and/or evaluated in real-time and is used, e.g., by computing platform(s) 202 to determine the likelihood that a defect exists. For example, based on the above information from the predictive index, the weighting module 212 may weight the sensors that detect these issues more highly than other sensors that are not relevant to cracking. Further, determining module 214 can check whether, based on information from the relevant sensor(s) 122, the factors for HIC are present at a given location, and if so, that can make it more likely that this module determines a defect to be present.

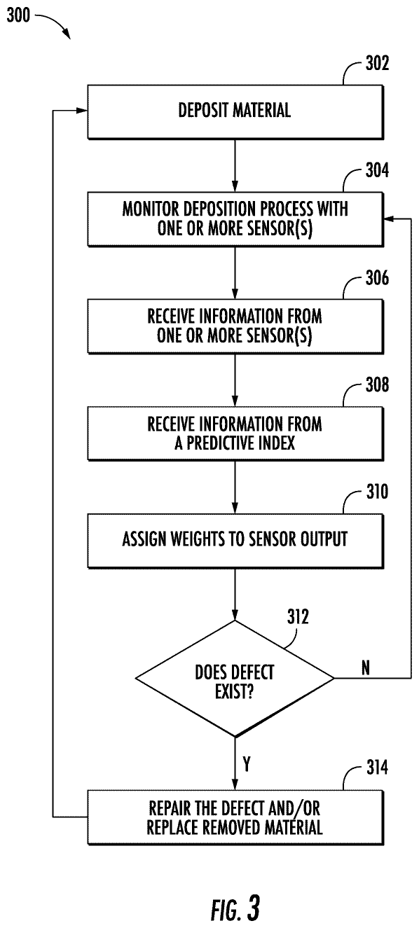

FIG. 3 illustrates a method 300 for identifying and/or correcting a defect in an additive manufacturing process, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in or via one or more processing devices (e.g., a digital processor, an analog processor, a digital circuit designed to process information, an analog circuit designed to process information, a state machine, and/or other mechanisms for electronically processing information) in combination with a manufacturing robot 120 (alone or in combination with a separate inspection and repair robot), one or more sensors 122, and a predictive index (e.g., as described above). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

In the illustrated embodiment, the method 300 begins with the deposition of material at operation 302. The material is deposited during an additive manufacturing process to form a component to near-net-shape and can be any metal or metal alloy. Operation 302 may be performed by a manufacturing robot.

At operation 304, the deposition of the material is monitored in real-time using one or more sensors 122 as discussed above. The one or more sensors 122 can provide feedback in the form of data or information.

Operation 306 includes receiving information from one or more sensors 122 during the deposition of material in an additive manufacturing process. In one aspect, operation 306 may be performed by one or more hardware processors configured by machine-readable instructions including a module that is the same as or similar to sensor communication module 208, in accordance with one or more implementations.

Operation 308 includes receiving information regarding the material being deposited and/or to the object or part being made from a predictive index. The predictive index can be stored in electronic storage 228, be part of an external resource 226, or located on a remote platform 204. In one aspect, operation 308 may be performed by one or more hardware processors configured by machine-readable instructions including a module that is the same as or similar to predictive index module 210, in accordance with one or more implementations.

Operation 310 includes weighting information received or determined from the one or more sensors 122. In one aspect, operation 310 may be performed by one or more hardware processors configured by machine-readable instructions including a module that is the same as or similar to weighting module 212, in accordance with one or more implementations.

Operation 312 includes determining, using the weighted information, the existence or likelihood of a defect in the material. In one aspect, operation 312 may be performed by one or more hardware processors configured by machine-readable instructions including a module that is the same as or similar to determining module 214, in accordance with one or more implementations. If a defect is indicated at operation 312, then the method continues to operation 314. If no defect is indicated at operation 312, then the method returns to operation 304.

Operation 314 includes repairing the defect and/or replacement of material that was removed during removal of the defect. This operation can include ensuring the newly added material is dimensionally correct and properly leveled. This operation also may comprise providing instructions to a manufacturing robot 120 and/or a dedicated inspection and repair robot. The instructions can be provided by one or more hardware processors configured by machine-readable instructions including a module that is the same as or similar to instructing module 216, in accordance with one or more implementations. In various embodiments, after operation 314 is completed, the deposition process continues at operation 302 until the manufacturing of the part or object is completed.

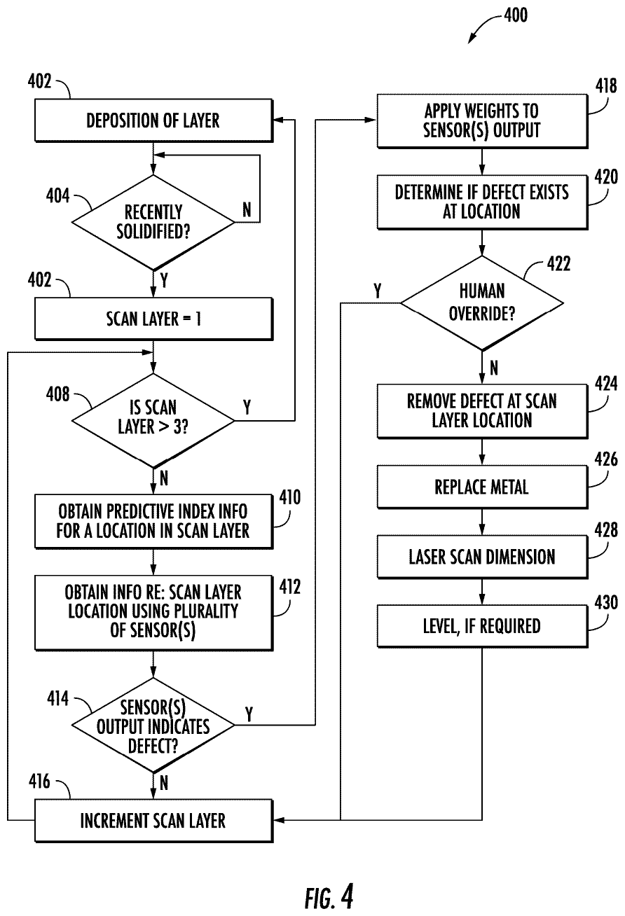

FIG. 4 illustrates a method 400 for identifying and/or correcting a defect in an additive manufacturing process in accordance with one or more implementations. As described in more detail below, method 400 can be performed during the manufacturing process at some or all locations in each layer of a build and at corresponding locations in the two prior layers in this example. In various embodiments, method 400 can perform a complete volumetric inspection of an object or part as it is built layer-by-layer. In various embodiments, the geometry of the part and the toolpath can determine the sequence of inspection locations. In various embodiments, method 400 does not interrupt the deposition process and takes place while deposition is ongoing. However, if a defect is identified, deposition may be stopped in some embodiments while the repair and replacement occurs. It will be appreciated that focusing on three-layer depths can enhance the quality of the build and allow the user also to evaluate the effectiveness of repairs that have occurred in prior layers. In other words, application of embodiments of the present invention across three (in this example) layers improves quality control.

The method 400 begins with the deposition of a layer of material at operation 402. The material is deposited during an additive manufacturing process to form a component to near-net-shape and can be any metal or metal alloy. Operation 402 may be performed by a manufacturing robot 120.

Next, in the illustrated embodiment a check is performed at operation 404 to determine whether recently deposited material at a location of interest is recently solidified. This check can be performed, for instance, via the computing platform(s) 202 or other controller controlling manufacturing robot 120 in combination with an infrared camera sensor 122. Of course, data received from sensors 122 regarding the material or its deposition at a given location can include data from the time of initial deposition through cooling and solidification of the material at that location. If the material at that location is not yet solidified, the method 400 returns to operation 404.

At operation 406, a scan layer counter is set equal to 1. In this regard, the scan layer counter corresponds to the layer of material under consideration in the operations of method 400 that follow, with 1 referring to the most-recently-deposited layer and 3 referring to the layer that is two layers below the most-recently-deposited layer. In method 400, the operations described below are performed on the layer corresponding to the scan layer counter. In various embodiments, of course, the scan layer counter need not be initialized at 1 and instead can be set equal to any number and incremented or decremented as multiple layers are scanned. At operation 408, computing platform(s) 202 or another dedicated controller may check whether the scan layer counter exceeds three, which in this example represents the number of layers being scanned. Again, this number can vary depending on the original setting for the scan layer counter and the number of layers to be scanned. If the counter exceeds three in this example, the method 400 returns to operation 402.

At operation 410, information for the material and/or part at the location and in the material layer under consideration is obtained via a predictive index. As discussed above, the predictive index can include, among other things, information associated with subsurface microstructure morphology for a specific material. The predictive index also may include or employ empirical data based upon experimental results to predict the susceptibility of microstructure to specific categories of defects at specific locations during an additive manufacturing process, for example cracking.

At operation 412, information is obtained from a plurality of sensors (e.g., sensors 122) regarding the location in the material layer under consideration. Operation 412 of course may occur prior to or simultaneously with operation 410, and in some embodiments information obtained from the plurality of sensors is fed into or employed by the predictive index. As noted above, each of the plurality of sensors defines or is associated with acceptance criteria. The acceptance criteria can include one or more threshold values to compare with measured information to indicate the likelihood of a defect or discontinuity in the deposited material. These values can be defined by the sensor's manufacturer, known to skilled artisans, or defined empirically, among other things. The values can be stored in sensors 122 themselves or in computing platform(s) 202.

Operation 414 checks whether the output of the plurality of sensors indicates the presence of a defect at the location. For example, operation 414 can check whether a baseline or threshold is met, such as whether a deposit layer designed to be 1.5 mm is within a tolerance of +/−5%, or whether the interpass temperature does not exceed 200 degrees Celsius and not more than 20% below that temperature. If none of the sensors indicate the presence of defect, then the scan layer counter is incremented by 1 at operation 416, and method 400 returns to operation 408. If one or more of the plurality of sensors indicates the presence of a defect at the location, the method 400 continues to operation 418. As discussed elsewhere herein, in some embodiments, only data output from sensors indicating the presence of a defect can be passed to the weighting operation, and in other embodiments, all data output from all sensors can be passed to the weighting operation.

At operation 418, weights are applied to the output of one or more of the plurality of sensors. As discussed above, in various embodiments, operation 418 can involve consideration of the reliability of each of the plurality of sensors at issue under the manufacturing conditions at issue, it can consider information received from the predictive index at operation 410, and it can consider the shape and/or geometry of the part at the location, among other things. For instance, if a non-contact probe suspects a microvoid or crack but the microstructure morphology predicts a crack resistant microstructure, then that may reduce the weighting of the information from the non-contact probe. In this manner, some of the data or information obtained from the plurality of sensors can be discounted while other data or information is elevated during the determination of whether a defect exists at a particular location. In various embodiments, operation 418 can be performed in a manner analogous to that described in connection with weighting module 212 above.

At operation 420, a determination is made regarding the likelihood or existence of a defect at the particular location. In this example, such a determination is made using the weighted data from operation 418, and in various embodiments operation 420 may be performed in a manner analogous to that described in connection with determining module 214 above. In an example where the output of each of the plurality of sensors is used to determine a probability that a defect exists, and where each such probability is assigned a weight at operation 418, operation 420 may comprise taking a weighted average of these probabilities to arrive at a single probability (e.g., a 60% likelihood of a defect). If this probability is above a predetermined threshold (e.g., 50%), then a defect is indicated at operation 420. Of course, as noted elsewhere herein, the predetermined threshold can be adjusted to various sensitivity levels. For instance, if the user decides that cracks can never be allowed, any defect that is suspected or determined to be a crack must be removed, even at a lower probability. In general, for less critical applications and/or locations, much greater certainty and/or alignment of the data can be required in order to generate removal and repair.

If a defect is indicated at operation 420, then operation 422 provides a human user with an opportunity to override this indication. If the human user elects to override and forego repair, then method 400 returns to operation 416 and the scan layer counter is incremented. If the human user does not do so, the method 400 continues to repair and replacement of material. In other embodiments, operation 422 may not be included and a human user is not provided with the opportunity to override.

At operation 424, method 400 comprises removal of the deposited material at the location in the material layer under consideration. (If a defect or faulty repair is discovered in a layer lower than the most-recently-deposited layer, then it will be appreciated that operation 424 may involve the removal of more material.) Operation 424 may be done with a carbide burr, for example, as described above, and it can be performed by the manufacturing robot 120 with a tool changing system or by a dedicated repair and inspection robot.

Upon removal of the defect, material is replaced at operation 426, e.g., to fill the void created by removal of the defect. The material is replaced using a manufacturing robot or the inspection and repair robot that is equipped with means to deposit material.

A laser scan of the replaced material can be performed at operation 428. The scan determines if the replaced material has proper dimensions and positioning. Any necessary leveling of the replaced material is performed at operation 430. Following operation 430, method 400 returns to operation 416 to increment the scan layer counter, and another layer can be scanned or the method can move to consideration of another location. Again, this process will continue until the build is completed.

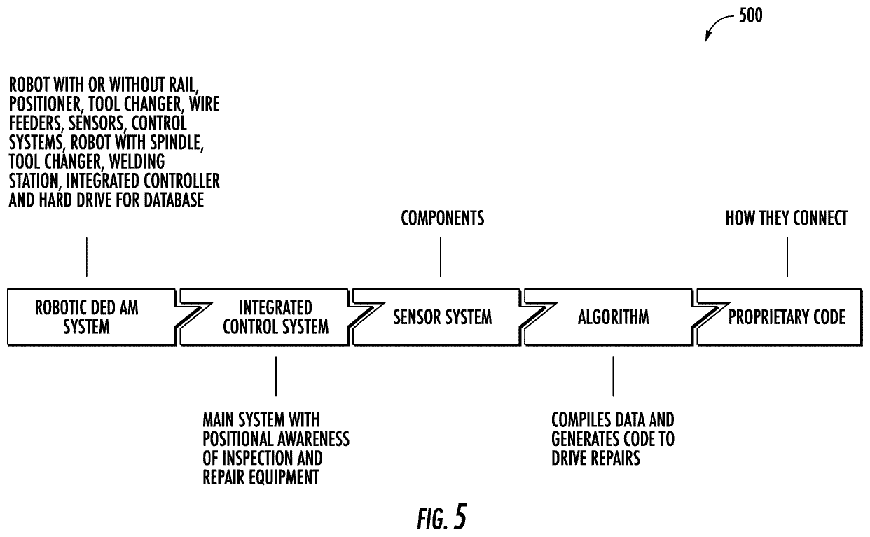

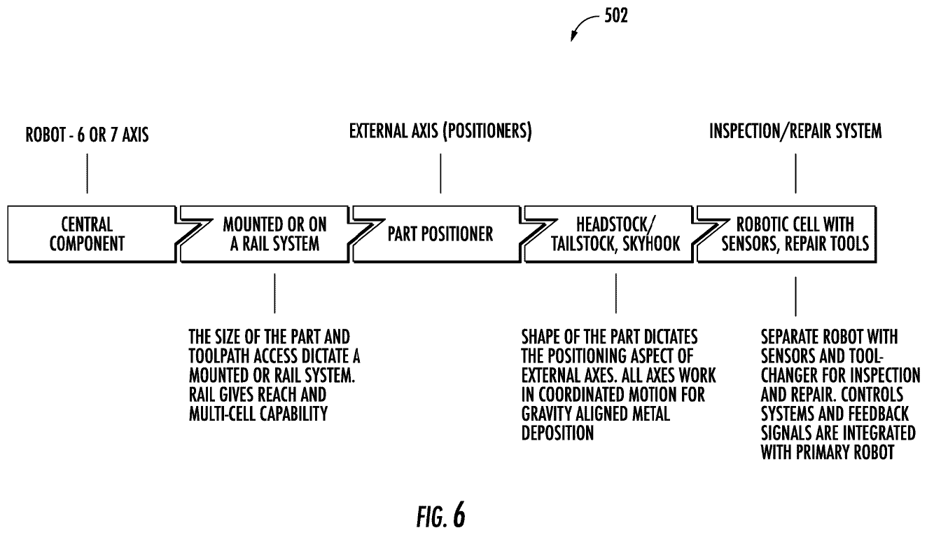

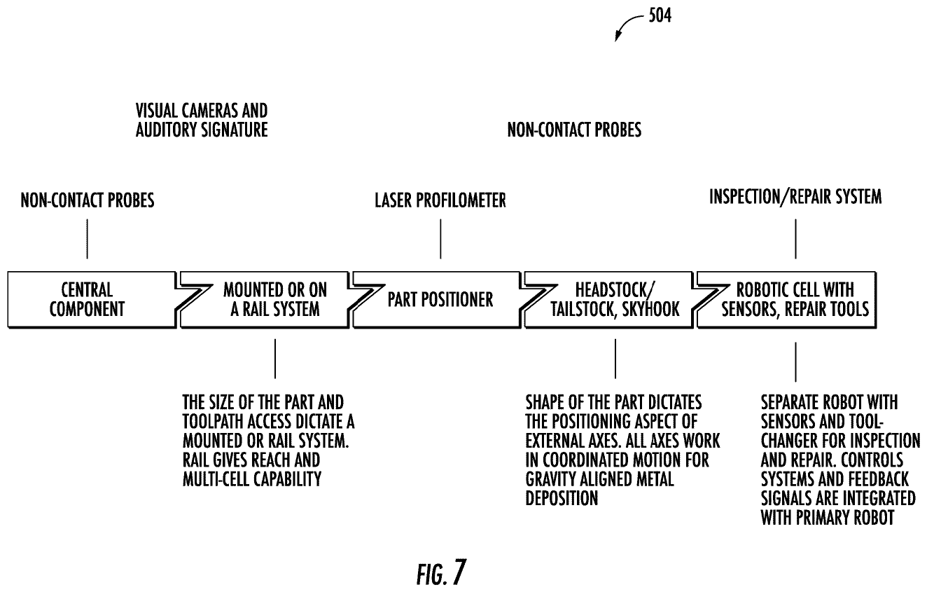

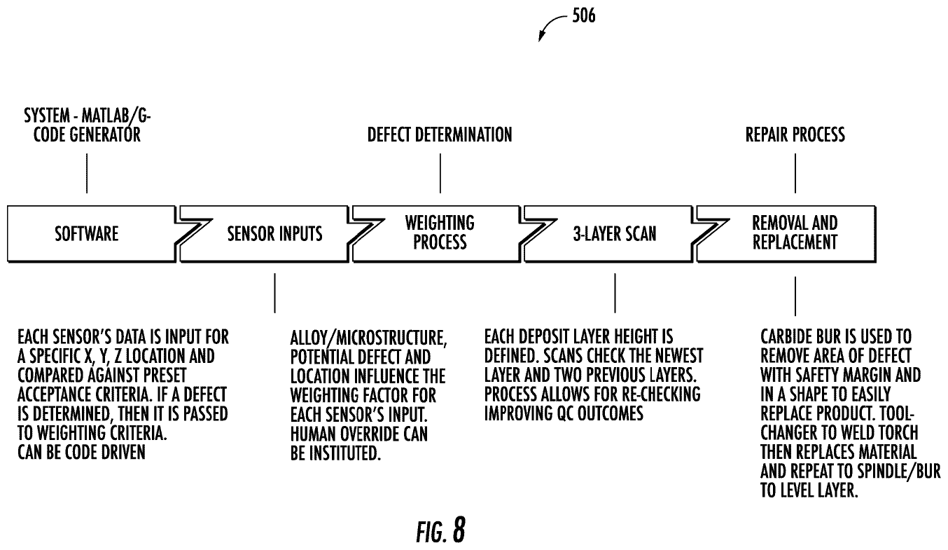

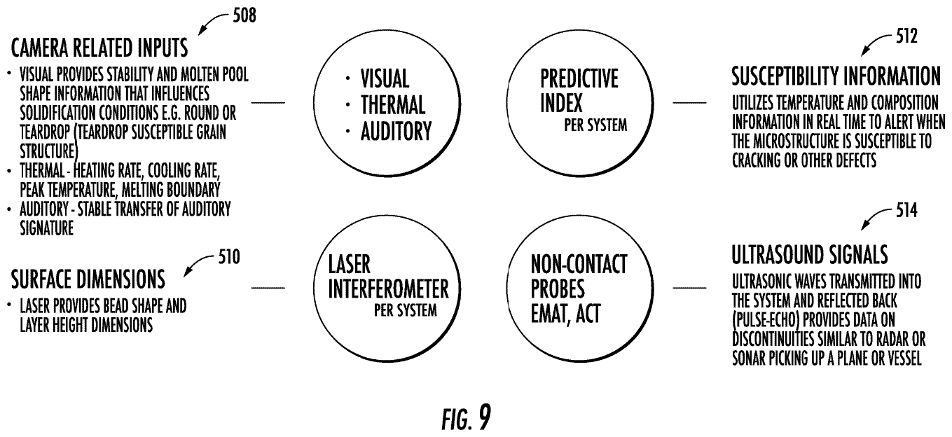

A further embodiment of the present invention is illustrated in FIGS. 5-10. With reference to these Figures, FIG. 5 is a block diagram of a system 500 for identifying and/or correcting a defect in accordance with yet another embodiment of the present disclosure, and FIG. 6 is a block diagram of a robotic system 502 that can be used with system 500. FIG. 7 is a block diagram of a sensory system 504 that can be used with system 500. FIG. 8 is a flowchart of an algorithm 506 for identifying and/or correcting a defect that can be used in system 500. FIG. 9 is a diagram of various inputs 508, 510, 512, and 514 that may be fed into the algorithm 506.

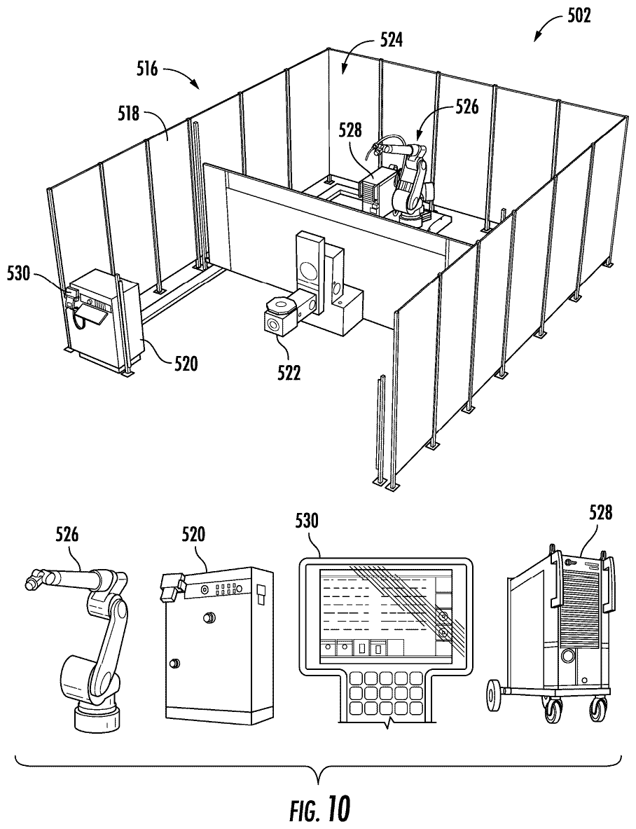

FIG. 10 is a perspective view of the robotic system 502, including detail views of certain components. In particular, robotic system 502 in this embodiment comprises a workspace 516 including one or more walls 518. A computing platform 520 is shown in a first work area 522 and is in electronic communication with a manufacturing robot 526 located in a second work area 524. A welding power source 528 also is in electrical communication with manufacturing robot 526. A user interface 530 is in communication with computing platform 520 and allows a user to initiate and control a build using robotic system 502.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps may be added or omitted without departing from the scope of this disclosure. Such steps may include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C or variations thereof are used to include both arrangements wherein two or more components are in direct physical contact and arrangements wherein the two or more components are not in direct contact with each other (e.g., the components are “coupled” via at least a third component), but still cooperate or interact with each other.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

I claim:

1. A system for identifying a defect in an additive manufacturing process, the system comprising:
a robotic arm configured for manufacturing a three-dimensional object by melting and solidifying a metal material via a heat source;
one or more sensors configured for monitoring the metal material during manufacture of the three-dimensional object;
memory comprising instructions;
at least one processor configured to execute the instructions to perform steps comprising:
receiving information from the one or more sensors during manufacture of the three-dimensional object;
receiving information regarding a microstructure of the metal material;
assigning a weight to the information from the one or more sensors based on one or more of the information received regarding the microstructure of the metal material, the operating characteristics of the one or more sensors, and the geometry of the three-dimensional object; and
determining, using the weighted information, the likelihood of a defect in the material.

2. The system of claim 1, wherein the one or more sensors are coupled with the robotic arm.

3. The system of claim 1, wherein the one or more sensors includes one or more of an electromagnetic acoustic transducer, an air coupled transducer, a welding microphone, a laser interferometer, a laser profilometer, a non-contact probe, a visual camera, an infrared camera, an ultrasound probe, a position sensor, and a bead profiler.

4. The system of claim 1, wherein at least one processor is configured to execute the instructions to perform the step of instructing the robotic arm for removing a defect.

5. The system of claim 1, wherein at least one processor is configured to execute the instructions to perform the step of instructing the robotic arm for repairing a defect.

6. The system of claim 1, wherein the metal material is selected from the group consisting of stainless steel, Nickel based alloy, advanced high strength steel, copper alloy, titanium alloy, and aluminum.

7. The system of claim 1, wherein the additive manufacturing process is a robotic arc directed energy deposition additive manufacturing process.

8. A method for identifying a defect in an additive manufacturing process for a three-dimensional object, the additive manufacturing process having predetermined manufacturing conditions, the method comprising:
receiving information from one or more sensors during deposition of a metal material by a manufacturing robot during manufacture of a three-dimensional object;
receiving information regarding operating characteristics of the one or more sensors and regarding the metal material's expected microstructure under the predetermined manufacturing conditions;
weighting the information from one or more sensors based on the received information; and
determining, using the weighted information, a first likelihood of a defect in the material.

9. The method of claim 8, further comprising repairing the defect.

10. The method of claim 9, further comprising overriding the step of repairing the defect.

11. The method of claim 8, further comprising determining a second likelihood of a defect in the material without using the weighted information based on the information received from the one or more sensors.

12. A system for identifying a defect in an additive manufacturing process, the system comprising:
a manufacturing robot configured for additive manufacturing of a three-dimensional object from a metal material under predetermined manufacturing conditions;
a plurality of sensors positioned to monitor deposited metal material during manufacture of the three-dimensional object, the sensors each having operational characteristics under the predetermined manufacturing conditions;
a predictive index comprising information regarding susceptibility of the deposited metal material to a manufacturing defect;
memory comprising instructions;
at least one processor in communication with the manufacturing robot, the one or more sensors, the predictive index, and the memory, the processor configured to execute the instructions to perform steps comprising:
receiving sensor data from each of the plurality of sensors during manufacture of the three-dimensional object;
receiving from the predictive index information regarding susceptibility of the deposited metal material to a manufacturing defect;
assigning a weight to the sensor data from each sensor of the plurality of sensors in part based on the operational characteristics of the plurality of sensors under the manufacturing conditions of the three-dimensional object; and
determining a first likelihood of a defect in the deposited material based on the weighted sensor data and the information regarding susceptibility of the deposited metal material to a defect.

13. The method of claim 12, wherein the operational characteristics of the plurality of sensors include one or more of an operating range, error, and reliability under the predetermined manufacturing conditions.

14. The method of claim 12, wherein the predictive index comprises a database separate from the memory.

15. The method of claim 12, wherein the information regarding susceptibility of the deposited material to a defect varies based one or more of the material's chemical composition, peak temperature, time at temperature, cooling rate, and location within the three-dimensional object.

16. The method of claim 12, further comprising determining a second likelihood of a defect in the deposited material based on the sensor data from the plurality of sensors without the weights being applied, wherein the second likelihood differs from the first likelihood.

17. The method of claim 12, wherein each sensor of the plurality of sensors has adjustable acceptance criteria that are compared with respective sensor data.

18. The method of claim 12, wherein the step of assigning a weight to the sensor data comprises ignoring one or more sensors of the plurality of sensors.

19. The method of claim 12, wherein the processor is configured to execute the steps repeatedly as the metal material is deposited during the additive manufacturing process.

20. The method of claim 12, wherein the step of determining a first likelihood of a defect in the deposited material comprises performing a weighted average.
